(19) United States
(12) Patent Application Publication
(10) Pub. No.: US 2022/0418071 A1
(43) Pub. Date: Dec. 29, 2022

(54) DISCRETE COMPONENT LINEAR CIRCUIT OF CIRCUIT

(71) Applicant: Dongguan Light Shines Electric Lighting Co., Ltd., Dongguan City (CN)

(72) Inventor: Qingjun Xu, Tongcheng City (CN)

(21) Appl. No.: 17/468,707

(22) Filed: Sep. 8, 2021

(30) Foreign Application Priority Data
Jun. 28, 2021 (CN) 202121438884.0

(51) Int. Cl. H05B 45/395; H05B 45/46; H05B 45/56; H05B 45/52; H01C 7/10

(52) U.S. Cl. CPC H05B 45/395; H05B 45/46; H05B 45/56; H05B 45/52; H01C 7/10

(57) ABSTRACT

A discrete component linear circuit of a line is provided, including a switch S1, a fuse F1, a varistor MOV1, a rectifier DB1, a triode Q1 to a triode Q6, and a resistor R1 to a resistor R6, wherein an input end of the switch S1 is connected to an input end L of a power supply for input, and an output end of the switch S1 is connected to an input end of the fuse F1. When an input voltage increases, a current increases, and resistance values of a thermistor T1, a thermistor T2 and a thermistor T3 increase due to temperature rise. The resistance increases synchronously when the voltage increases, so that the current is maintained in a relatively stable interval. Therefore, the voltage bearing capacity when an LED lamp works is increased, and more LED lamps may be used in parallel.

### TECHNICAL FIELD

The utility model relates to the technical field of discrete component wiring, and in particular to a discrete component linear circuit of a line.

### BACKGROUND

When an existing bulb is in use, due to the instability of an external power supply, an input unit will increase, the resistance in the circuit will maintain unchanged, and the current in the circuit will increase correspondingly. When the current increases, the current will exceed the rated working current of the bulb, and the bulb will be burnt. Therefore, when the bulbs are used in parallel, the risk in use will increase correspondingly. In some occasions, many bulbs need to be used in parallel at the same time, and an existing wiring method cannot meet the above requirements. For this purpose, a discrete component linear circuit of a line is provided.

### SUMMARY

An objective of the utility model is to provide a discrete component linear circuit of a line, so that the voltage bearing capacity when an LED lamp works is improved, more LED lamps may be used in parallel, and the problems in the prior art are solved.

To achieve the above objective, the utility model provides the following technical solution: a discrete component linear circuit of a line includes a switch S1, a fuse F1, a varistor MOV1, a rectifier DB1, a triode Q1 to a triode Q6, and a resistor R1 to a resistor R6, wherein an input end of the switch S1 is connected to an input end L of a power supply for input, an output end of the switch S1 is connected to an input end of the fuse F1, an output end of the fuse F1 is connected to an AC1 end of the rectifier DB1 for input and is connected to an input end of the varistor MOV1, and an AC2 end of the rectifier DB1 is connected to an input end N of the power supply and is connected to an output end of the varistor MOV1; V+of the rectifier DB1 is connected to an input end of an LED lamp and is connected to an input end of a capacitor C1, and a V-terminal of the rectifier DB1 is connected to an output end of the capacitor C1 and is grounded; a collector of the triode Q1, a collector of the triode Q3 and a collector of the triode Q5 are connected to an output end of the LED lamp, a base of the triode Q1 is connected to an emitter thereof and then is connected to a base of the triode Q2, the emitter of the triode Q1 is connected to an input end of the resistor R2, an output end of the resistor R2 is connected to an emitter of the triode Q2 and then is grounded, a collector of the triode Q2 is connected to an output end of the resistor R1, and an input end of the resistor R1 is connected to an input end of an LED lamp;

a base of the triode Q3 is connected to an emitter thereof and then is connected to a base of the triode Q4, the emitter of the triode Q3 is connected to an input end of the resistor R4, an output end of the resistor R4 is connected to an emitter of the triode Q4 and then is grounded, a collector of the triode Q4 is connected to an output end of the resistor R3, and an input end of the resistor R3 is connected to an input end of an LED lamp; and

a base of the triode Q5 is connected to an emitter thereof and then is connected to a base of the triode Q6, the emitter of the triode Q5 is connected to an input end of the resistor R6, an output end of the resistor R6 is connected to an emitter of the triode Q6 and then is grounded, a collector of the triode Q6 is connected to an output end of the resistor R5, and an input end of the resistor R5 is connected to an input end of the LED lamp.

Preferably, a thermistor T1 is connected between the resistor R1 and an input end of an LED lamp.

Preferably, a thermistor T2 is connected between the resistor R3 and an input end of an LED lamp.

Preferably, a thermistor T3 is connected between the resistor R4 and an input end of an LED lamp.

Preferably, the triode Q1 to the triode Q6 have the same model number.

The discrete component linear circuit of the line can be switched on and off and controlled through simple line control. When an input voltage increases, a current increases, and resistance values of a thermistor T1, a thermistor T2 and a thermistor T3 increase due to temperature rise. The resistance increases synchronously when the voltage increases, so that the current is maintained in a relatively stable interval. Therefore, the voltage bearing capacity when an LED lamp works is increased, and more LED lamps may be used in parallel.

### DESCRIPTION OF THE DRAWINGS

FIG. 1 is a schematic circuit diagram of the utility model; and

FIG. 2 is an existing wiring circuit diagram of the utility model.

### DETAILED DESCRIPTION OF EMBODIMENTS

The technical solutions in the embodiments of the utility model are described below clearly and completely with reference to the accompanying drawings in the embodiments of the utility model. Apparently, the described embodiments are a part, but not all, of the embodiments of the utility model. All other embodiments obtained by a person of ordinary skill in the art based on the embodiments of the utility model without inventive efforts fall within the scope of protection of the utility model.

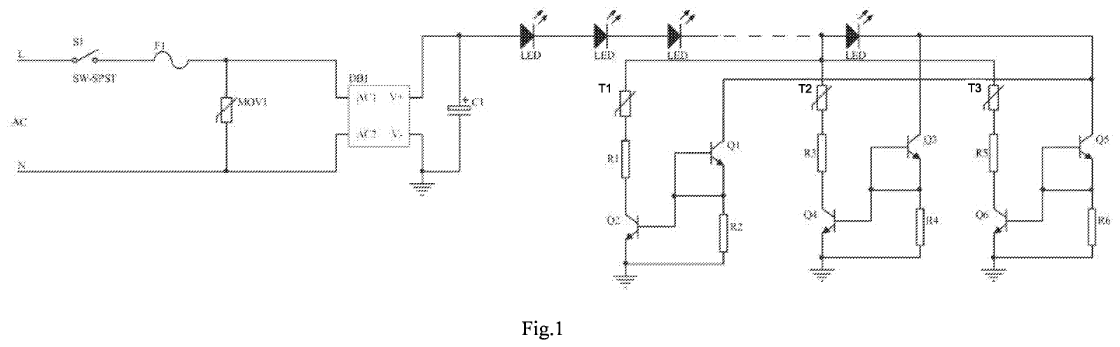

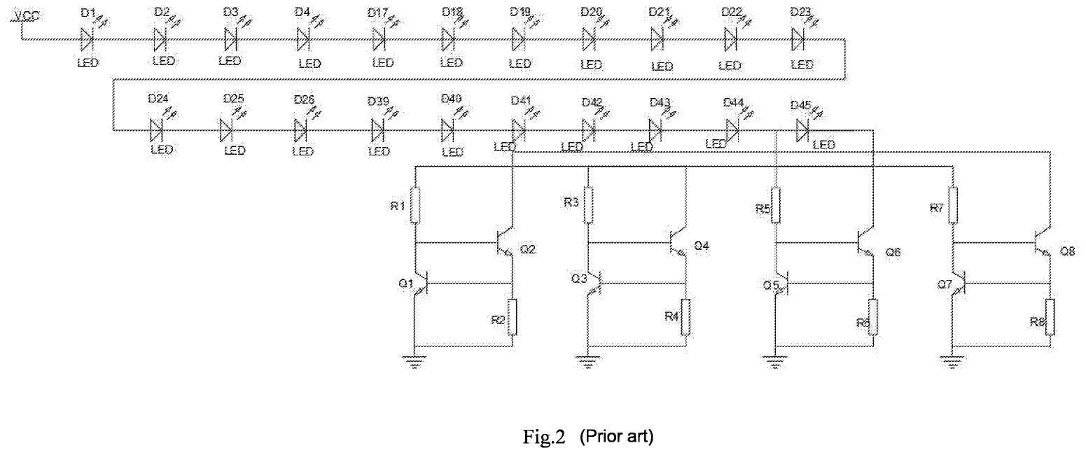

Referring to FIG. 1 to FIG. 2, a discrete component linear circuit of a line includes a switch S1, a fuse F1, a varistor MOV1, a rectifier DB1, a triode Q1 to a triode Q6, and a resistor R1 to a resistor R6, wherein an input end of the switch S1 is connected to an input end L of a power supply for input, an output end of the switch S1 is connected to an input end of the fuse F1, an output end of the fuse F1 is connected to an AC1 end of the rectifier DB1 for input and is connected to an input end of the varistor MOV1, and an AC2 end of the rectifier DB1 is connected to an input end N of the power supply and is connected to an output end of the varistor MOV1; V+ of the rectifier DB1 is connected to an input end of an LED lamp and is connected to an input end of a capacitor C1, and a V-terminal of the rectifier DB1 is connected to an output end of the capacitor C1 and is grounded; a collector of the triode Q1, a collector of the triode Q3 and a collector of the triode Q5 are connected to an output end of the LED lamp, a base of the triode Q1 is connected to an emitter thereof and then is connected to a base of the triode Q2, the emitter of the triode Q1 is connected to an input end of the resistor R2, an output end of the resistor R2 is connected to an emitter of the triode Q2 and then is grounded, a collector of the triode Q2 is connected to an output end of the resistor R1, and an input end of the resistor R1 is connected to an input end of an LED lamp; a thermistor T1 is connected between the resistor R1 and an input end of an LED; a base of the triode Q3 is connected to an emitter thereof and then is connected to a base of the triode Q4, the emitter of the triode Q3 is connected to an input end of the resistor R4, an output end of the resistor R4 is connected to an emitter of the triode Q4 and then is grounded, a collector of the triode Q4 is connected to an output end of the resistor R3, and an input end of the resistor R3 is connected to an input end of an LED lamp; a second thermistor T2 is connected between the resistor R3 and an input end of an LED lamp; a base of the triode Q5 is connected to an emitter thereof and then is connected to a base of the triode Q6, the emitter of the triode Q5 is connected to an input end of the resistor R6, an output end of the resistor R6 is connected to an emitter of the triode Q6 and then is grounded, a collector of the triode Q6 is connected to an output end of the resistor R5, and an input end of the resistor R5 is connected to an input end of the LED lamp; a third thermistor T3 is connected between the resistor R4 and an input end of an LED lamp; and the triode Q1 to the triode Q6 have the same model number.

The discrete component linear circuit of the line is controlled by the switch S1 to be energized or not, and the fuse F1 plays a front end protection role. When the circuit is heated caused by overload or excessive current, the fuse F1 is disconnected to protect the entire line.

The input power supply is rectified by the rectifier DB1 and then is filtered by the capacitor C1 to supply power for the LED lamp. Through comparison between FIG. 1 and FIG. 2, it can be seen that the thermistor T1, the thermistor T2 and the thermistor T3 are connected and generate heat during work. The resistance increases when the temperature rises, so when the input voltage increases, the current increases, and the resistance values of the thermistor T1, the thermistor T2 and the thermistor T3 increase due to temperature rise. The resistance increases synchronously when the voltage increases, so that the current is maintained in a relatively stable interval. Therefore, the voltage bearing capacity when the LED lamp works is improved, and more LED lamps may be used in parallel.

In conclusion: the discrete component linear circuit of the line can be switched on and off and controlled through simple line control; the thermistor T1, the thermistor T2 and the thermistor T3 are connected and generate heat during work; the resistance increases when the temperature rises, so when the input voltage increases, the current increases, and the resistance values of the thermistor T1, the thermistor T2 and the thermistor T3 increase due to temperature rise; the resistance increases synchronously when the voltage increases, so that the current is maintained in a relatively stable interval; therefore, the voltage bearing capacity when an LED lamp works is increased, and more LED lamps may be used in parallel.

It should be noted that in this specification, relational terms such as first and second are used only to differentiate an entity or operation from another entity or operation, and do not require or imply that any actual relation or sequence exists between these entities or operations. In addition, the terms “comprise”, “include” and any other variants thereof are intended to cover non-exclusive inclusion, so that a process, a method, an article, or a device that includes a series of elements not only includes these very elements, but may also include other elements not expressly listed, or also include elements inherent to this process, method, article, or device.

Although the embodiments of the utility model have been illustrated and described, it should be understood that those of ordinary skill in the art may make various changes, modifications, replacements and variations to the above embodiments without departing from the principle and spirit of the utility model, and the scope of the utility model is limited by the appended claims and their legal equivalents.

What is claimed is:

1. A discrete component linear circuit of a line, comprising a switch (S1), a fuse (F1), a varistor (MOV1), a rectifier (DB1), a first triode (Q1), a second triode (Q2), a third triode (Q3), a fourth triode (Q4), a fifth triode (Q5), and a sixth triode (Q6), and a first resistor (R1), a second resistor (R2), a third resistor (R3), a fourth resistor (R4), a fifth resistor (R5), and a sixth resistor (R6), wherein an input end of the switch (S1) is connected to an AC mains live-line connecting end (L) of a power supply for input, an output end of the switch (S1) is connected to an input end of the fuse (F1), an output end of the fuse (F1) is connected to a first connecting end (AC1) of the rectifier (DB1) for input and is connected to an input end of the varistor (MOV1), and a second connecting end (AC2) of the rectifier (DB1) is connected to an AC mains null-line connecting end (N) of the power supply and is connected to an output end of the varistor (MOV1); a third connecting end (V+) of the rectifier (DB1) is connected to an input end of an LED lamp and is connected to an input end of a capacitor (C1), and a fourth connecting end (V−) of the rectifier (DB1) is connected to an output end of the capacitor (C1) and is grounded; a collector of the first triode (Q1), a collector of the third triode (Q3) and a collector of the fifth triode (Q5) are connected to an output end of the LED lamp, a base of the first triode (Q1) is connected to an emitter thereof and then is connected to a base of the second triode (Q2), the emitter of the first triode (Q1) is connected to an input end of the second resistor (R2), an output end of the second resistor (R2) is connected to an emitter of the second triode (Q2) and then is grounded, a collector of the second triode (Q2) is connected to an output end of the first resistor (R1), and an input end of the first resistor (R1) is connected to an input end of an LED lamp; a base of the third triode (Q3) is connected to an emitter thereof and then is connected to a base of the fourth triode (Q4), the emitter of the third triode (Q3) is connected to an input end of the fourth resistor (R4), an output end of the fourth resistor (R4) is connected to an emitter of the fourth triode (Q4) and then is grounded, a collector of the fourth triode (Q4) is connected to an output end of the third resistor (R3), and an input end of the third resistor (R3) is connected to an input end of an LED lamp; and a base of the fifth triode (Q5) is connected to an emitter thereof and then is connected to a base of the sixth triode (Q6), the emitter of the fifth triode (Q5) is connected to an input end of the sixth resistor (R6), an output end of the sixth resistor (R6) is connected to an emitter of the sixth triode (Q6) and then is grounded, a collector of the sixth triode (Q6) is connected to an output end of the fifth resistor (R5), and an input end of the fifth resistor (R5) is connected to an input end of the LED lamp.

2. The discrete component linear circuit of the line according to claim 1, wherein a first thermistor (T1) is connected between the first resistor (R1) and an input end of an LED lamp.

3. The discrete component linear circuit of the line according to claim 1, wherein a second thermistor (T2) is connected between the third resistor (R3) and an input end of an LED lamp.

4. The discrete component linear circuit of the line according to claim 1, wherein a third thermistor (T3) is connected between the fifth resistor (R5) and an input end of an LED lamp.

5. The discrete component linear circuit of the line according to claim 1, wherein the first triode (Q1), the second triode (Q2), the third triode (Q3), the fourth triode (Q4), the fifth triode (Q5), and the sixth triode (Q6) have the same model number.
